(19) United States
(12) Patent Application Publication
(10) Pub. No.: US 2016/0057525 A1
(43) Pub. Date: Feb. 25, 2016

(54) PARAMETRIC TRANSDUCER HEADPHONES

(71) Applicant: Turtle Beach Corporation, Poway, CA (US)

(72) Inventors: Brian Alan Kappus, San Diego, CA (US); Elwood Grant Norris, Poway, CA (US)

(21) Appl. No.: 14/464,178

(22) Filed: Aug. 20, 2014

(51) Int. Cl. H04R 1/10; H04R 1/00

(52) U.S. Cl. CPC H04R 1/1058; H04R 1/00

(57) ABSTRACT

An ultrasonic audio headphone system includes two ultrasonic speakers, each having a backing plate and a flexible layer disposed adjacent the backing plate. The backing plate and the flexible layer are each configured to be electrically coupled to a respective one of a pair of signal lines carrying the audio modulated ultrasonic carrier signal from the amplifier, wherein upon application of the audio modulated ultrasonic carrier signal, the flexible layer is configured to launch a pressure-wave representation of the audio modulated ultrasonic carrier signal into the air.

### TECHNICAL FIELD

The present disclosure relates generally to parametric emitters for a variety of applications. More particularly, some embodiments relate to an ultrasonic emitter headphone system.

### BACKGROUND OF THE INVENTION

Non-linear transduction results from the introduction of sufficiently intense, audio-modulated ultrasonic signals into an air column. Self-demodulation, or down-conversion, occurs along the air column resulting in the production of an audible acoustic signal. This process occurs because of the known physical principle that when two sound waves with different frequencies are radiated simultaneously in the same medium, a modulated waveform including the sum and difference of the two frequencies is produced by the non-linear (parametric) interaction of the two sound waves. When the two original sound waves are ultrasonic waves and the difference between them is selected to be an audio frequency, an audible sound can be generated by the parametric interaction.

Parametric audio reproduction systems produce sound through the heterodyning of two acoustic signals in a non-linear process that occurs in a medium such as air. The acoustic signals are typically in the ultrasound frequency range. The non-linearity of the medium results in acoustic signals produced by the medium that are the sum and difference of the acoustic signals. Thus, two ultrasound signals that are separated in frequency can result in a difference tone that is within the 60 Hz to 20,000 Hz range of human hearing.

### SUMMARY

Embodiments of the technology described herein include an ultrasonic headphone system.

In accordance with one embodiment, an ultrasonic headphone system comprises two ultrasonic emitters. Each of the two ultrasonic emitters comprises a backing plate and a flexible layer disposed adjacent the backing plate. The backing plate and the flexible layer are each configured to be electrically coupled to a respective one of a pair of signal lines carrying the audio modulated ultrasonic carrier signal from the amplifier, wherein upon application of the audio modulated ultrasonic carrier signal, the flexible layer is configured to launch a pressure-wave representation of the audio modulated ultrasonic carrier signal into the air. The ultrasonic headphone system further comprises two headphone housings, each of the headphone housings containing one of the two ultrasonic emitters. In various embodiments, each housing may also contain an amplifier, or one amplifier (e.g., a stereo or other multi-channel amplifier) can be provided for the signals being sent to the emitters in each housing.

In accordance with another example embodiment, an ultrasonic headphone system, includes an amplifier or amplifiers, and two headphone earpiece housings into which first and second ultrasonic audio speakers are each mounted, respectively. The ultrasonic audio speakers include a backing plate; and a flexible layer disposed adjacent the backing plate, the backing plate and the flexible layer each configured to be electrically coupled to a respective one of a pair of signal lines carrying the audio modulated ultrasonic carrier signal from the amplifier, wherein upon application of the audio modulated ultrasonic carrier signal, the flexible layer is configured to launch a pressure-wave representation of the audio modulated ultrasonic carrier signal into the air. The ultrasonic headphone system further includes a signal-processing module (which can be separate or combined) for equalizing, compressing, filtering, and first and second audio signals and modulating the audio signals onto respective ultrasonic carriers; and two amplifiers for amplifying the audio modulated ultrasonic carrier signals.

In accordance with other example embodiments, ultrasonic headphones comprise two headphone earpiece housings, and first and second ultrasonic audio speakers, each mounted in a respective one of the earpiece housings. Each of the first and second ultrasonic speakers comprises a backing plate and a flexible layer disposed adjacent the backing plate. The backing plate and the flexible layer are each configured to be electrically coupled to a respective one of a pair of signal lines carrying an audio modulated ultrasonic carrier signal from an amplifier, wherein upon application of the audio modulated ultrasonic carrier signal, the flexible layer is configured to launch a pressure-wave representation of the audio modulated ultrasonic carrier signal into the air.

In accordance with still another example embodiment, ultrasonic headphones comprise two headphone earpiece housings and a first set of audio speakers mounted in each of the earpiece housings. Each of the audio speakers includes a backing plate and a flexible layer disposed adjacent the backing plate. The backing plate and the flexible layer are each configured to be electrically coupled to a respective one of a pair of signal lines carrying an audio modulated ultrasonic carrier signal from an amplifier, wherein upon application of the audio modulated ultrasonic carrier signal, the flexible layer is configured to launch a pressure-wave representation of the audio modulated ultrasonic carrier signal into the air. Each of the audio speakers further comprises a second set of audio speakers mounted in each of the earpiece housings. The second set of audio speakers may comprise a dynamic loudspeaker.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the accompanying figures. The drawings are provided for purposes of illustration only and merely depict typical or example embodiments of the invention. These drawings are provided to facilitate the reader's understanding of the systems and methods described herein, and shall not be considered limiting of the breadth, scope, or applicability of the claimed invention.

Some of the figures included herein illustrate various embodiments of the invention from different viewing angles. Although the accompanying descriptive text may refer to elements depicted therein as being on the “top,” “bottom” or “side” of an apparatus, such references are merely descriptive and do not imply or require that the invention be implemented or used in a particular spatial orientation unless explicitly stated otherwise.

FIG. 1 is a diagram illustrating an ultrasonic sound system suitable for use with the emitter technology described herein.

FIG. 2 is a diagram illustrating another example of a signal processing system that is suitable for use with the emitter technology described herein.

FIG. 3 is a blow-up diagram illustrating an example emitter in accordance with one embodiment of the technology described herein.

FIG. 4 is a diagram illustrating a cross sectional view of an assembled emitter in accordance with the example illustrated in FIG. 3.

FIG. 5 is a diagram illustrating another example configuration of an ultrasonic emitter in accordance with one embodiment of the technology described herein.

FIG. 6A is a diagram illustrating an example of a simple driver circuit that can be used to drive the emitters disclosed herein.

FIG. 6B is a diagram illustrating an example of a simple circuit to generate a bias voltage at the emitter drawing the necessary voltage from the signal itself. In this example, the circuit is designed to bias at 300V but other voltages are possible by changing diode ZD1.

FIG. 6C is a diagram illustrating a cutaway view of an example of a pot core that can be used to form a pot-core inductor.

FIG. 7 is a diagram illustrating a conventional headphone system.

FIG. 8 is a diagram illustrating an ultrasonic sound system in accordance with one embodiment of the technology described herein.

FIG. 9 is a diagram illustrating a perspective view of an example configuration of an ultrasonic emitter with an integrated amplifier in accordance with one embodiment of the technology described herein.

FIG. 10 is a diagram illustrating an example ultrasonic headphone system in use in accordance with various embodiments of the technology described herein.

FIG. 11 is a cutaway diagram illustrating an example ultrasonic emitter configuration of an example ultrasonic headphone in accordance with one embodiment of the technology described herein.

The figures are not intended to be exhaustive or to limit the invention to the precise form disclosed. It should be understood that the invention can be practiced with modification and alteration, and that the invention be limited only by the claims and the equivalents thereof.

### DESCRIPTION

Embodiments of the systems and methods described herein provide a HyperSonic Sound (HSS) audio system or other ultrasonic audio system for a variety of different applications. Certain embodiments provide audio headphones incorporating ultrasonic emitters.

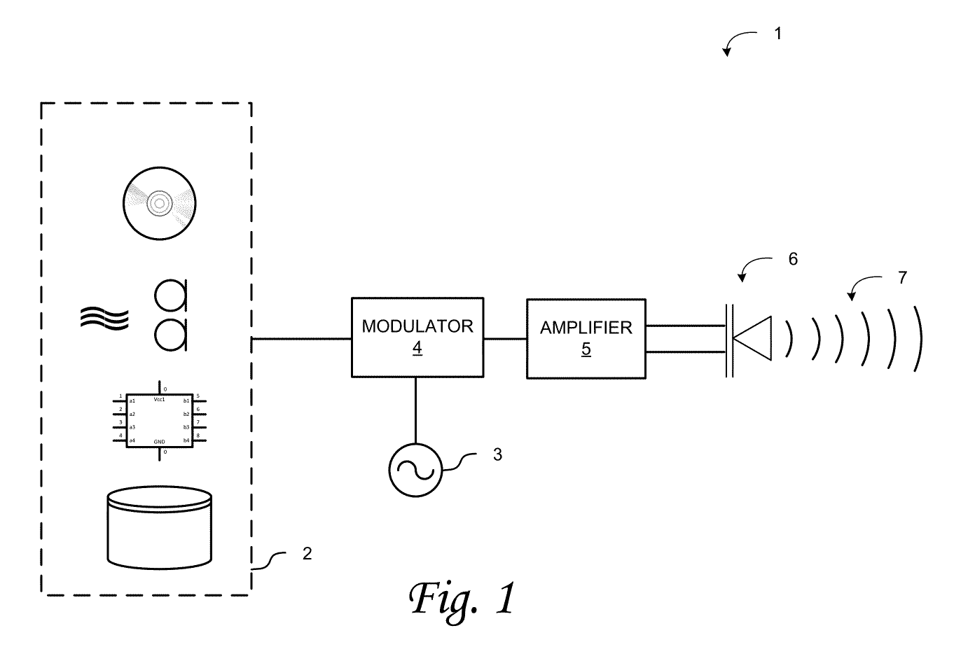

FIG. 1 is a diagram illustrating an ultrasonic sound system suitable for use in conjunction with the systems and methods described herein. In this exemplary ultrasonic system 1, audio content from an audio source 2, such as, for example, a microphone, memory, a data storage device, streaming media source, MP3, CD, DVD, set-top-box, or other audio source is received. The audio content may be decoded and converted from digital to analog form, depending on the source. The audio content received by the audio system 1 is modulated onto an ultrasonic carrier of frequency f1, using a modulator. The modulator typically includes a local oscillator 3 to generate the ultrasonic carrier signal, and modulator 4 to modulate the audio signal on the carrier signal. The resultant signal is a double- or single-sideband signal with a carrier at frequency f1 and one or more side lobes. In some embodiments, the signal is a parametric ultrasonic wave or a HSS signal. In most cases, the modulation scheme used is amplitude modulation, or AM, although other modulation schemes can be used as well. Amplitude modulation can be achieved by multiplying the ultrasonic carrier by the information-carrying signal, which in this case is the audio signal. The spectrum of the modulated signal can have two sidebands, an upper and a lower side band, which are symmetric with respect to the carrier frequency, and the carrier itself.

The modulated ultrasonic signal is provided to the transducer 6, which launches the ultrasonic signal into the air creating ultrasonic wave 7. When played back through the transducer at a sufficiently high sound pressure level, due to nonlinear behavior of the air through which it is ‘played’ or transmitted, the carrier in the signal mixes with the sideband(s) to demodulate the signal and reproduce the audio content. This is sometimes referred to as self-demodulation. Thus, even for single-sideband implementations, the carrier is included with the launched signal so that self-demodulation can take place.

Although the system illustrated in FIG. 1 uses a single transducer to launch a single channel of audio content, one of ordinary skill in the art after reading this description will understand how multiple mixers, amplifiers and transducers can be used to transmit multiple channels of audio using ultrasonic carriers. The ultrasonic transducers can be mounted in any desired location depending on the application.

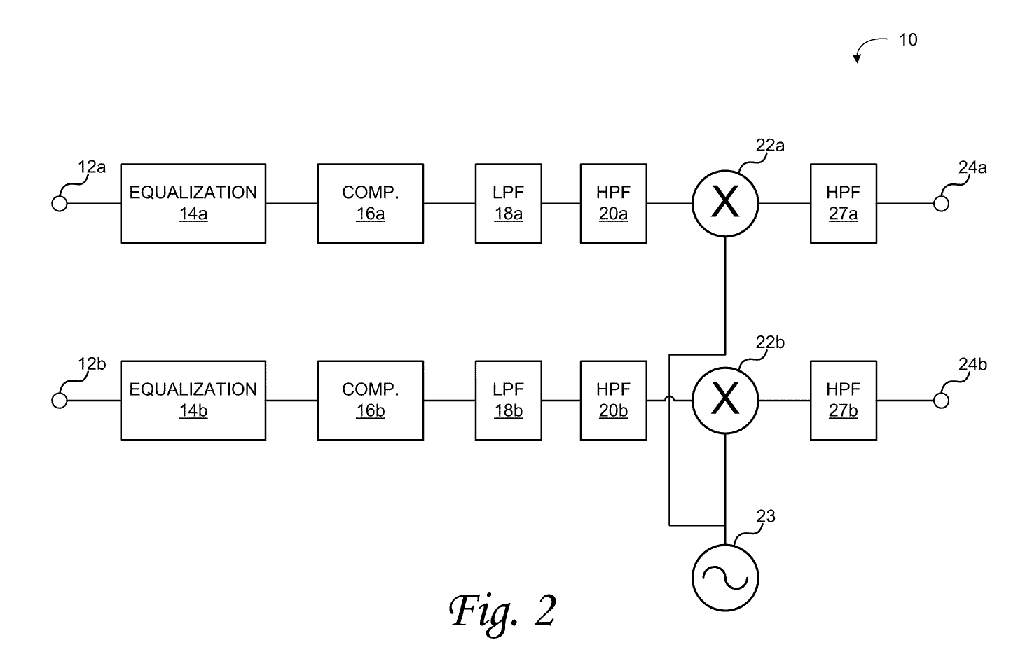

One example of a signal processing system 10 that is suitable for use with the technology described herein is illustrated schematically in FIG. 2. In this embodiment, various processing circuits or components are illustrated in the order (relative to the processing path of the signal) in which they are arranged according to one implementation. It is to be understood that the components of the processing circuit can vary, as can the order in which the input signal is processed by each circuit or component. Also, depending upon the embodiment, the processing system 10 can include more or fewer components or circuits than those shown.

Also, the example shown in FIG. 1 is optimized for use in processing two input and output channels (e.g., a “stereo” signal), with various components or circuits including substantially matching components for each channel of the signal. It will be understood by one of ordinary skill in the art after reading this description that the audio system can be implemented using a single channel (e.g., a “monaural” or “mono” signal), two channels (as illustrated in FIG. 2), or a greater number of channels.

Referring now to FIG. 2, the example signal processing system 10 can include audio inputs that can correspond to left 12a and right 12b channels of an audio input signal. Equalizing networks 14a, 14b can be included to provide equalization of the signal. The equalization networks can, for example, boost or suppress predetermined frequencies or frequency ranges to increase the benefit provided naturally by the emitter/inductor combination of the parametric emitter assembly.

After the audio signals are equalized compressor circuits 16a, 16b can be included to compress the dynamic range of the incoming signal, effectively raising the amplitude of certain portions of the incoming signals and lowering the amplitude of certain other portions of the incoming signals. More particularly, compressor circuits 16a, 16b can be included to narrow the range of audio amplitudes. In one aspect, the compressors lessen the peak-to-peak amplitude of the input signals by a ratio of not less than about 2:1. Adjusting the input signals to a narrower range of amplitude can be done to minimize distortion, which is characteristic of the limited dynamic range of this class of modulation systems. In other embodiments, the equalizing networks 14a, 14b can be provided after compressors 16a, 16b, to equalize the signals after compression.

Low pass filter circuits 18a, 18b can be included to provide a cutoff of high portions of the signal, and high pass filter circuits 20a, 20b providing a cutoff of low portions of the audio signals. In one exemplary embodiment, low pass filters 18a, 18b are used to cut signals higher than about 15-20 kHz, and high pass filters 20a, 20b are used to cut signals lower than about 20-200 Hz.

The low pass filters 18a, 18b can be configured to eliminate higher frequencies that, after modulation, could result in the creation of unwanted audible sound. By way of example, if a low pass filter cuts frequencies above 15 kHz, and the carrier frequency is approximately 44 kHz, the difference signal will not be lower than around 29 kHz, which is still outside of the audible range for humans. However, if frequencies as high as 25 kHz were allowed to pass the filter circuit, the difference signal generated could be in the range of 19 kHz, which is within the range of human hearing.

In the example system 10, after passing through the low pass and high pass filters, the audio signals are modulated by modulators 22a, 22b. Modulators 22a, 22b, mix or combine the audio signals with a carrier signal generated by oscillator 23. For example, in some embodiments a single oscillator (which in one embodiment is driven at a selected frequency of 40 kHz to 150 kHz, which range corresponds to readily available crystals that can be used in the oscillator) is used to drive both modulators 22a, 22b. By utilizing a single oscillator for multiple modulators, an identical carrier frequency is provided to multiple channels being output at 24a, 24b from the modulators. Using the same carrier frequency for each channel lessens the risk that any audible beat frequencies may occur. Alternatively, different carrier frequencies may be provided for each channel (in the case of multiple channels). It should be noted that in embodiments where the signal processing system 10 is utilized for headphone applications (as will be discussed below), there is acoustic isolation, thereby avoiding any mixing.

High-pass filters 27a, 27b can also be included after the modulation stage. High-pass filters 27a, 27b can be used to pass the modulated ultrasonic carrier signal and ensure that no audio frequencies enter the amplifier via outputs 24a, 24b. Accordingly, in some embodiments, high-pass filters 27a, 27b can be configured to filter out signals below about 25 kHz.

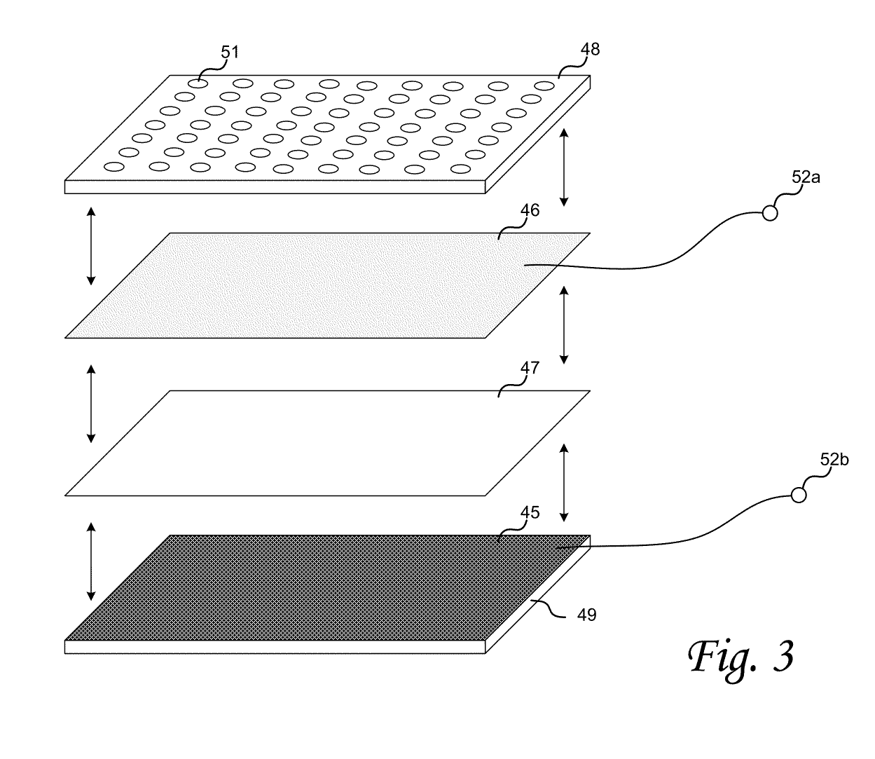

FIG. 3 is a blow-up diagram illustrating an example emitter in accordance with one embodiment of the technology described herein. The example emitter shown in FIG. 3 includes one conductive surface 45, another conductive surface 46, an insulating layer 47 and a grating 48. In the illustrated example, conductive layer 45 is disposed on a backing plate 49. In various embodiments, backing plate 49 is a non-conductive backing plate and serves to insulate conductive surface 45 on the back side. For example, conductive surface 45 and backing plate 49 can be implemented as a metalized layer deposited on a non-conductive, or relatively low conductivity, substrate. As a further example, a plastic or other like substance can be used to form a textured backplate substrate, which can be metalized. Such a substrate can be injection molded, machined or manufactured using other like techniques.

As a further example, conductive surface 45 and backing plate 49 can be implemented as a printed circuit board (or other like material) with a metalized layer deposited thereon. As another example, conductive surface 45 can be laminated or sputtered onto backing plate 49, or applied to backing plate 49 using various deposition techniques, including vapor or evaporative deposition, and thermal spray, to name a few. As yet another example, conductive layer 45 can be a metalized film.

Conductive surface 45 can be a continuous surface or it can have slots, holes, cut-outs of various shapes, or other non-conductive areas. Additionally, conductive surface 45 can be a smooth or substantially smooth surface, or it can be rough or pitted. For example, conductive surface 45 can be embossed, stamped, sanded, sand blasted, formed with pits or irregularities in the surface, deposited with a desired degree of ‘orange peel’ or otherwise provided with texture.

Conductive surface 45 need not be disposed on a dedicated backing plate 49. Instead, in some embodiments, conductive surface 45 can be deposited onto a member that provides another function, such as a member that is part of a speaker housing. Conductive surface 45 can also be deposited directly onto a wall or other location where the emitter is to be mounted, and so on.

Conductive surface 46 provides another pole of the emitter. Conductive surface can be implemented as a metalized film, wherein a metalized layer is deposited onto a film substrate (not separately illustrated). The substrate can be, for example, polypropylene, polyimide, polyethylene terephthalate (PET), biaxially-oriented polyethylene terephthalate (e.g., Mylar, Melinex or Hostaphan), Kapton, or other substrate. In some embodiments, the substrate has low conductivity and, when positioned so that the substrate is between the conductive surfaces of layers 45 and 46, acts as an insulator between conductive surface 45 and conductive surface 46. In other embodiments, there is no non-conductive substrate, and conductive surface 46 is a sheet of conductive material. Graphene or other like conductive materials can be used for conductive surface 46, whether with or without a substrate.

In addition, in some embodiments conductive surface 46 (and its insulating substrate where included) is separated from conductive surface 45 by an insulating layer 47. Insulating layer 47 can be made, for example, using PET, axially or biaxially-oriented polyethylene terephthalate, polypropylene, polyimide, or other insulative film or material.

To drive the emitter with enough power to get sufficient ultrasonic pressure level, arcing can occur where the spacing between conductive surface 46 and conductive surface 45 is too thin. However, where the spacing is too thick, the emitter will not achieve resonance, nor will it be sensitive enough. In one embodiment, insulating layer 47 is a layer of about 0.92 mil in thickness. In some embodiments, insulating layer 47 is a layer from about 0.90 to about 1 mil in thickness. In further embodiments, insulating layer 47 is a layer from about 0.75 to about 1.2 mil in thickness. In still further embodiments, insulating layer 47 is as thin as about 0.33 or 0.25 mil in thickness. Other thicknesses can be used, and in some embodiments a separate insulating layer 47 is not provided. For example, some embodiments rely on an insulating substrate of conductive layer 46 (e.g., as in the case of a metalized film) to provide insulation between conductive surfaces 45 and 46. One benefit of including an insulating layer 47 is that it can allow a greater level of bias voltage to be applied across the first and second conductive surfaces 45, 46 without arcing. When considering the insulative properties of the materials between the two conductive surfaces 45, 46, one should consider the insulative value of layer 47, if included, and the insulative value of the substrate, if any, on which conductive layer 46 is deposited.

A grating 48 can be included on top of the stack. Grating 48 can be made of a conductive or non-conductive material. In some embodiments, grating 48 can be the grating that forms the external speaker grating for the speaker. Because grating 48 is in contact in some embodiments with the conductive surface 46, grating 48 can be made using a non-conductive material to shield users from the bias voltage present on conductive surface 46. Grating 48 can include holes 51, slots or other openings. These openings can be uniform, or they can vary across the area, and they can be thru-openings extending from one surface of grating 48 to the other. Grating 48 can be of various thicknesses. For example, grating 48 can be approximately 60 mils, although other thicknesses can be used. It should be noted that metal mesh material can be also used to effectuate shielding, for example, 165 thread-per-inch metal mesh having a 2 mil wire diameter. In order to be electrically isolated from conductive surface 46, spacing can be provided by way of a plastic frame. The metal mesh can be glued or otherwise adhesively attached to the plastic frame under tension so as to be sufficiently structurally strong to prevent being pushed into conductive surface 46.

Electrical contacts 52a, 52b are used to couple the modulated carrier signal into the emitter. An example of a driver circuit for the emitter is described below.

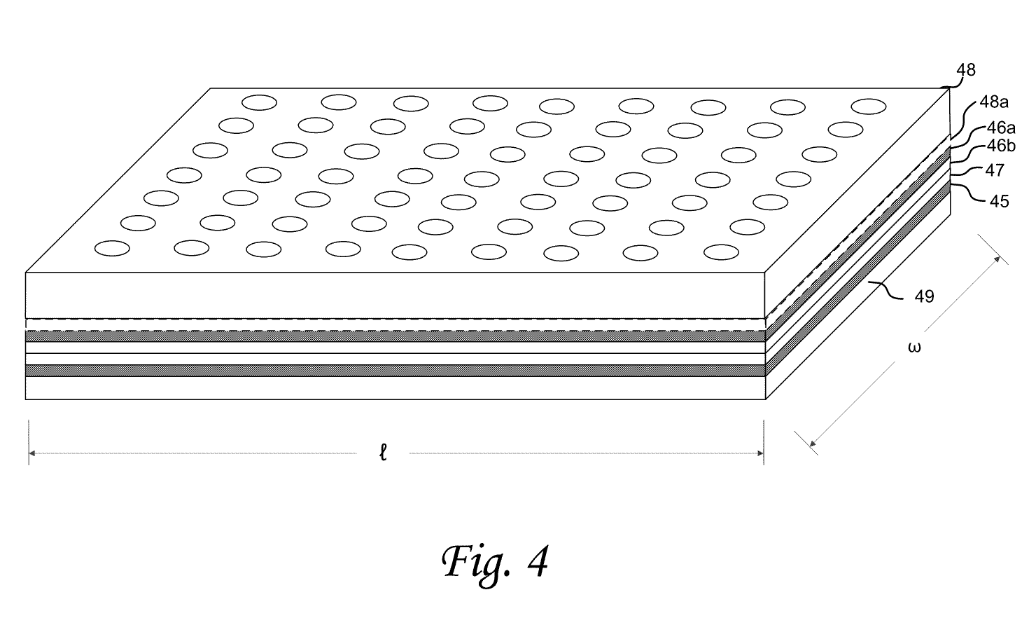

FIG. 4 is a diagram illustrating a cross sectional view of an assembled emitter in accordance with the example illustrated in FIG. 3. As illustrated, this embodiment includes backing plate 49, conductive surface 45, conductive surface 46 (comprising a conductive surface 46a deposited on a substrate 46b), insulating layer 47 between conductive surface 45 and conductive surface 46a, and grating 48. Optionally, and as described above, a metal-mesh shielding layer may be used. Accordingly, the emitter may also include an additional insulating layer 48a. The dimensions in these and other figures, and particularly the thicknesses of the layers, are not drawn to scale.

The emitter can be made to just about any dimension. In one application the emitter is of length, e, 3 inches and its width, w, is 2 inches although other dimensions, both larger and smaller are possible. Practical ranges of length and width can be similar lengths and widths of conventional headphone speakers. Greater emitter area can lead to a greater sound output, but may also require higher bias voltages.

Table 1 describes examples of metalized films that can be used to provide conductive surface 46. Low sheet resistance or low ohms/square is preferred for conductive surface 46. Accordingly, films on table 1 having <5 and <1 Ohms/Square exhibited better performance than films with higher Ohms/Square resistance. Films exhibiting 2 k or greater Ohms/Square did not provide high output levels in development testing. Kapton can be a desirable material because it is relatively temperature insensitive in temperature ranges expected for operation of the emitter. Polypropylene may be less desirable due to its relatively low capacitance. A lower capacitance in the emitter means a larger inductance (and hence a physically larger inductor) is needed to form a resonant circuit. As table 1 illustrates, films used to provide conductive surface 46 can range from about 0.25 mil to 3 mils, inclusive of the substrate.

TABLE 1

| Thick- | | | |
|---|---|---|---|
| ness | | Material | Ohms/Sq |
| 3 | mil | Mylar | 2000 |
| .8 | mil | Polypropylene | 5 |
| 3 | mil | Meta material | 2000+ |
| ¼ | mil | Mylar | 2000+ |
| ¼ | mil | Mylar | 2000+ |
| ¼ | mil | Mylar | 2000+ |
| ¼ | mil | Mylar | 2000+ |
| 3 | mil | Mylar | 168 |
| .8 | mil | Polypropylene | <10 |
| .92 | mil | Mylar | 100 |
| 2 | mil | Mylar | 160 |
| .8 | mil | Polypropylene | 93 |
| 3 | mil | Mylar | <1 |
| 1.67 | | Polypropylene | 100 |
| .8 | mil | Polypropylene | 43 |
| 3 | mil | Mylar | <1 |
| 3 | mil | Kapton | 49.5 |
| 3 | mil | Mylar | <5 |
| 3 | mil | Meta material | |
| 3 | mil | Mylar | <5 |
| 3 | mil | Mylar | <1 |
| 1 | mil | Kapton | <1 |
| ¼ | mil | Mylar | 5 |
| .92 | mil | Mylar | 10 |
| ¼ | mil | Mylar | <1 |
| ⅛ | mil | Mylar | <10 |

Although not shown in table 1, another film that can be used to provide conductive surface 46 is the DE 320 Aluminum/Polyimide film available from the Dunmore Corporation. This film is a polyimide-based product, aluminized on two sides. It is approximately 1 mil in thickness and provides <1 Ohms/Square. As these examples illustrate, any of a number of different metalized films can be provided as conductive surfaces 45, 46. Metalization is typically performed using sputtering or a physical vapor deposition process. Aluminum, nickel, chromium, copper or other conductive materials can be used as the metallic layer, keeping in mind the preference for low Ohms/Square material.

In other embodiments, materials such as graphene can be used as the conductive surfaces. Graphene films can be produced with the desired levels of conductivity (e.g., similar to the films described above), and can, in some cases be made as transparent films. A graphene film can be combined with, or a graphene layer deposited on, an insulating layer (such as, e.g., insulating layer 47) to provide electrical isolation between the conductive layers. Graphene films can be created by a number of techniques. In one example, graphene can be deposited by chemical vapor deposition onto sheets of copper foil (or other sacrificial layer). The graphene can then be coated with a thin layer of adhesive polymer sacrificial layer dissolved away. The graphene can be left on the polymer or pressed against another desired insulating substrate, such as Mylar or Kapton, and the polymer layer removed by heating. The graphene can be treated, for example, with nitric acid, to improve its electrical conductivity.

Metalized or conductive films together with the backing plate typically have a natural frequency at which they will resonate. For some film/backplate combinations, their natural resonant frequency can be in the range of approximately 30-150 kHz. For example, with a backing plate as described above, some 0.33 mil Kapton films resonate at approximately 54 kHz, while some 1.0 mil Kapton films resonate at about 34 kHz. Accordingly, the film/backplate combination and the carrier frequency of the ultrasonic carrier can be chosen such that the carrier frequency matches the resonant frequency of the film/backplate combination. Selecting a carrier frequency at or near the resonant frequency of the film/backplate combination can increase the output of the emitter. For example, the carrier frequency can be selected to be the same or substantially the same as the resonant frequency of the film/backplate combination. In other embodiments, the carrier frequency can be selected to be within 5% or 10% or 15% of the resonant frequency of the film/backplate combination. In other embodiments, the carrier frequency can be selected to be within 20%, 25% or 30% of the resonant frequency of the film/backplate combination. Other frequencies can be selected.

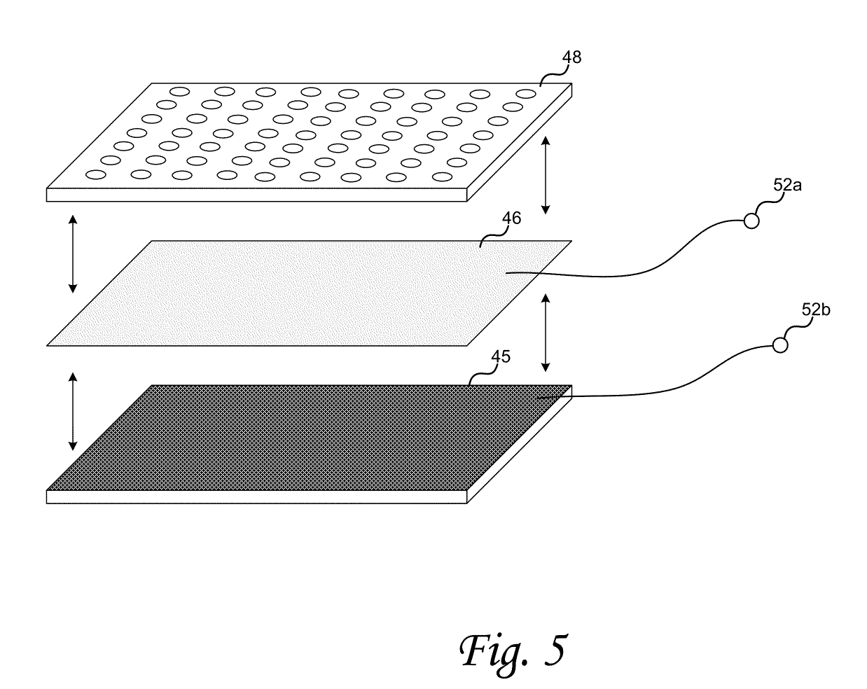

FIG. 5 is a diagram illustrating another example configuration of an ultrasonic emitter in accordance with one embodiment of the technology described herein. The example in FIG. 5 includes conductive surfaces 45 and 46 and grating 48. The difference between the embodiment shown in FIG. 5, and that shown in FIGS. 3 and 4 is that the embodiment shown in FIG. 5 does not include separate insulating layer 47. Layers 45, 46 and 48 can be implemented using the same materials as described above with reference to FIGS. 3 and 4. Particularly, to avoid shorting or arcing between conductive surfaces 45, 46, conductive surface 46 is deposited on a substrate with insulative properties. For example, metalized Mylar or Kapton films like the films shown in Table 1 can be used to implement conductive surface 46, with the film oriented such that the insulating substrate is positioned between conductive surfaces 45, 46.

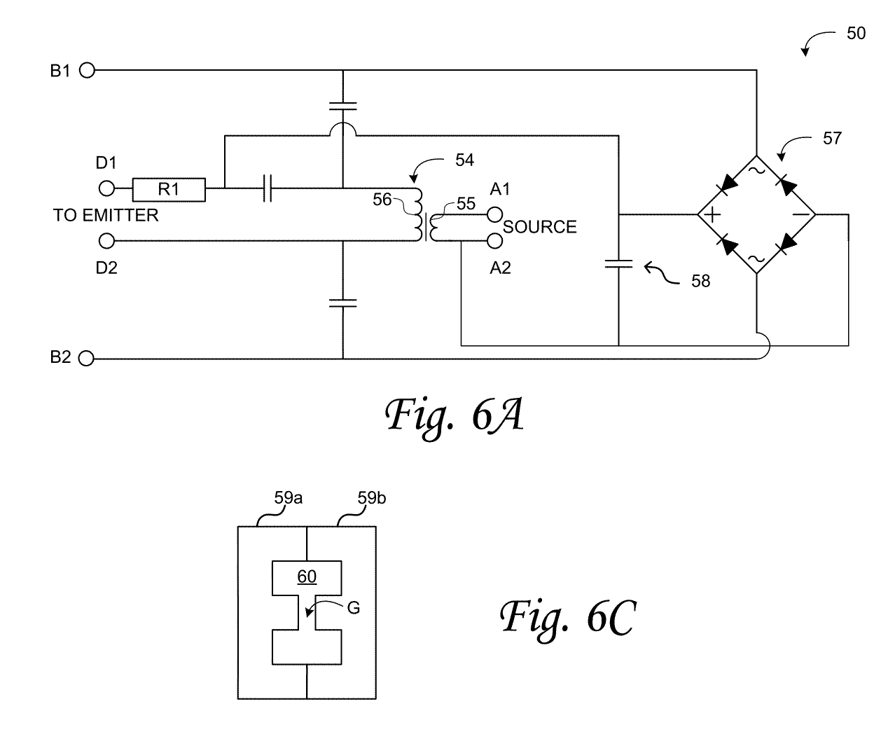

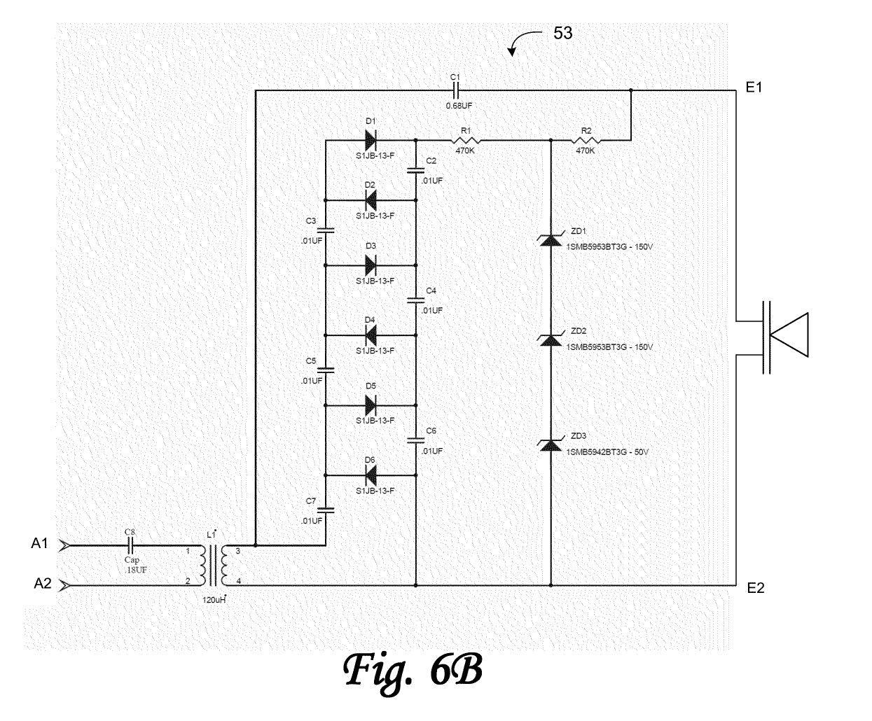

FIG. 6A is a diagram illustrating an example of a simple driver circuit that can be used to drive the emitters disclosed herein. As would be appreciated by one of ordinary skill in the art, where multiple emitters are used (e.g., for stereo applications), a driver circuit 50 can be provided for each emitter. In some embodiments, the driver circuit 50 is provided in the same housing or assembly as the emitter. In other embodiments, the driver circuit 50 is provided in a separate housing. This driver circuit is only an example, and one of ordinary skill in the art will appreciate that other driver circuits can be used with the emitter technology described herein.

Typically, the modulated signal from the signal processing system 10 is electronically coupled to an amplifier (not shown). The amplifier can be part of, and in the same housing or enclosure as driver circuit 50. Alternatively, the amplifier can be separately housed. After amplification, the signal is delivered to inputs A1, A2 of driver circuit 50. In the embodiments described herein, the emitter assembly includes an emitter that can be operable at ultrasonic frequencies. The emitter (not shown in FIG. 6A) is connected to driver circuit 50 at contacts D1, D2. An inductor 54 forms a parallel resonant circuit with the emitter. By configuring the inductor 54 in parallel with the emitter, the current circulates through the inductor and emitter and a parallel resonant circuit can be achieved. Accordingly, the capacitance of the emitter becomes important, because lower capacitance values of the emitter require a larger inductance to achieve resonance at a desired frequency. Accordingly, capacitance values of the layers, and of the emitter as a whole can be an important consideration in emitter design.

A bias voltage is applied across terminals B1, B2 to provide bias to the emitter. Full wave rectifier 57 and filter capacitor 58 provide a DC bias to the circuit across the emitter inputs D1, D2. Ideally, the bias voltage used is approximately twice (or greater) the reverse bias that the emitter is expected to take on. This is to ensure that bias voltage is sufficient to pull the emitter out of a reverse bias state. In one embodiment, the bias voltage is on the order of 300-450 Volts, although voltages in other ranges can be used. For example, 350 Volts can be used. For ultrasonic emitters, bias voltages are typically in the range of a few hundred to several hundred volts.

Although series arrangements can be used, arranging inductor 54 in parallel with the emitter can provide advantages over series arrangement. For example, in this configuration, resonance can be achieved in the inductor-emitter circuit without the direct presence of the amplifier in the current path. This can result in more stable and predictable performance of the emitter, and less power being wasted as compared to series configuration.

Obtaining resonance at optimal system performance can improve the efficiency of the system (that is, reduce the power consumed by the system) and reduce the heat produced by the system.

With a series arrangement, the circuit causes wasted current to flow through the inductor. As is known in the art, the emitter will perform best at (or near) the point where electrical resonance is achieved in the circuit. However, the amplifier introduces changes in the circuit, which can vary by temperature, signal variance, system performance, etc. Thus, it can be more difficult to obtain (and maintain) stable resonance in the circuit when the inductor 54 is oriented in series with the emitter (and the amplifier).

FIG. 6B is a diagram illustrating an example of a simple bias circuit that can be used with the emitters disclosed herein. As would be appreciated by one of ordinary skill in the art, where multiple emitters are used (e.g., for stereo applications), a bias circuit 53 can be provided for each emitter. In some embodiments, the bias circuit 53 is provided in the same housing or assembly as the emitter. In other embodiments, the bias circuit 53 is provided in a separate housing. This driver circuit is only an example, and one of ordinary skill in the art will appreciate that other driver circuits can be used with the emitter technology described herein.

Typically, the modulated signal from the signal processing system 10 is electronically coupled to an amplifier (not shown). The amplifier can be part of, and in the same housing or enclosure as driver circuit 53. Alternatively, the amplifier can be separately housed. After amplification, the signal is delivered to inputs A1, A2 of circuit 53. In the embodiments described herein, the emitter assembly includes an emitter that can be operable at ultrasonic frequencies. The emitter is connected to driver circuit 53 at contacts E1, E2. An advantage of the circuit shown in FIG. 5B is that the bias can be generated from the ultrasonic carrier signal, and a separate bias supply is not required. In operation, diodes D1-D6 in combination with capacitors C2-C7 are configured to operate as rectifier and voltage multiplier. Particularly, diodes D1-D6 and capacitors C2-C7 are configured as a rectifier and voltage sextupler resulting in a DC bias voltage of up to approximately four times the carrier voltage amplitude across nodes E1, E2. Other levels of voltage multiplication can be provided using similar, known voltage multiplication techniques.

Capacitor C1 is chosen large enough to hold the bias and present an open circuit to the DC voltage at E1 (i.e., to prevent the DC from shorting to ground), but small enough to allow the modulated ultrasonic carrier pass to the emitter. Resistors R1, R2 form a voltage divider, and in combination with Zener diodes ZD1-ZD3, limit the bias voltage to the desired level, which in the illustrated example is 300 Volts. Capacitor C8 may be optional.

Inductor 54 can be of a variety of types known to those of ordinary skill in the art. However, inductors generate a magnetic field that can “leak” beyond the confines of the inductor. This field can interfere with the operation and/or response of the emitter. Also, many inductor/emitter pairs used in ultrasonic sound applications operate at voltages that generate large amounts of thermal energy. Heat can also negatively affect the performance of a parametric emitter.

For at least these reasons, in most conventional parametric sound systems the inductor is physically located a considerable distance from the emitter. While this solution addresses the issues outlined above, it adds another complication. The signal carried from the inductor to the emitter is can be a relatively high voltage (on the order of 160 V peak-to-peak or higher). As such, the wiring connecting the inductor to the emitter must be rated for high voltage applications. Also, long runs of the wiring may be necessary in certain installations, which can be both expensive and dangerous, and can also interfere with communication systems not related to the parametric emitter system.

The inductor 54 (included as a component as shown in the configurations of FIGS. 6A and 6B) can be implemented using a pot core inductor. A pot core inductor is housed within a pot core that is typically formed of a ferrite material. This confines the inductor windings and the magnetic field generated by the inductor. Typically, the pot core includes two ferrite halves 59a, 59b that define a cavity 60 within which the windings of the inductor can be disposed. See FIG. 6C. An air gap G can be included to increase the permeability of the pot core without affecting the shielding capability of the core. Thus, by increasing the size of the air gap G, the permeability of the pot core is increased. However, increasing the air gap G also requires an increase in the number of turns in the inductor(s) held within the pot core in order to achieve a desired amount of inductance. Thus, an air gap can increase permeability and at the same time reduce heat generated by the pot core inductor, without compromising the shielding properties of the core.

In the examples illustrated in FIGS. 6A and 6B, a dual-winding step-up transformer is used. However, the primary 55 and secondary 56 windings can be combined in what is commonly referred to as an autotransformer configuration. Either or both the primary and secondary windings can be contained within the pot core.

As discussed above, it is desirable to achieve a parallel resonant circuit with inductor 54 and the emitter. It is also desirable to match the impedance of the inductor/emitter pair with the impedance expected by the amplifier. This generally requires increasing the impedance of the inductor emitter pair. It may also be desirable to achieve these objectives while locating the inductor physically near the emitter. Therefore, in some embodiments, the air gap of the pot core is selected such that the number of turns in the primary winding 55 present the impedance load expected by the amplifier. In this way, each loop of the circuit can be tuned to operate at an increased efficiency level. Increasing the air gap in the pot core provides the ability to increase the number of turns in inductor element 55 without changing the desired inductance of inductor element 56 (which would otherwise affect the resonance in the emitter loop). This, in turn, provides the ability to adjust the number of turns in inductor element 55 to match the impedance load expected by the amplifier.

An additional benefit of increasing the size of the air gap is that the physical size of the pot core can be reduced. Accordingly, a smaller pot core transformer can be used while still providing the same inductance to create resonance with the emitter.

The use of a step-up transformer provides additional advantages to the present system. Because the transformer “steps-up” from the direction of the amplifier to the emitter, it necessarily “steps-down” from the direction of the emitter to the amplifier. Thus, any negative feedback that might otherwise travel from the inductor/emitter pair to the amplifier is reduced by the step-down process, thus minimizing the effect of any such event on the amplifier and the system in general (in particular, changes in the inductor/emitter pair that might affect the impedance load experienced by the amplifier are reduced).

In one embodiment, 30/46 enameled Litz wire is used for the primary and secondary windings. Litz wire comprises many thin wire strands, individually insulated and twisted or woven together. Litz wire uses a plurality of thin, individually insulated conductors in parallel. The diameter of the individual conductors is chosen to be less than a skin-depth at the operating frequency, so that the strands do not suffer an appreciable skin effect loss. Accordingly, Litz wire can allow better performance at higher frequencies.

A bias voltage is applied across terminals B1, B2 to provide bias to the emitter. Full wave rectifier 57 and filter capacitor 58 provide a DC bias to the circuit across the emitter inputs D1, D2. Ideally, the bias voltage used is approximately twice (or greater) the reverse bias that the emitter is expected to take on. This is to ensure that bias voltage is sufficient to pull the emitter out of a reverse bias state. In one embodiment, the bias voltage is on the order of 350-420 Volts. In other embodiments, other bias voltages can be used. For ultrasonic emitters, bias voltages are typically in the range of a few hundred to several hundred volts.

Although not shown in the figures, where the bias voltage is high enough, arcing can occur between conductive layers 45, 46. This arcing can occur through the intermediate insulating layers as well as at the edges of the emitter (around the outer edges of the insulating layers. Accordingly, the insulating layer 47 can be made larger in length and width than conductive surfaces 45, 46, to prevent edge arcing. Likewise, where conductive layer 46 is a metalized film on an insulating substrate, conductive layer 46 can be made larger in length and width than conductive layer 45, to increase the distance from the edges of conductive layer 46 to the edges of conductive layer 45.

Resistor R1 (FIG. 6A) can be included to lower or flatten the Q factor of the resonant circuit. Resistor R1 is not needed in all cases and air as a load will naturally lower the Q. Likewise, thinner Litz wire in inductor 54 can also lower the Q so the peak isn't overly sharp.

As described herein, various embodiments can be configured to transmit one or more channels of audio using ultrasonic carriers. The transmission of audio using ultrasonic carriers can be used in a variety of different scenarios/contexts as will be described in greater detail below. For example, various embodiments may be utilized in or for implementing directed/targeted or isolated sound systems, specialized audio effects, hearing amplifiers/aids, as well as sound alteration.

Various technologies described herein can also be applied to hearing aids or other assistive hearing devices. For example, demodulation of an audio-encoded ultrasonic carrier signal can be accomplished within a listener's skull or within the listener's inner ear. In particular, a hearing response profile of a listener to an audio modulated ultrasonic carrier signal can be determined, and audio content can be adjusted to at least partially compensate for the listener's hearing response profile. It should be noted that the use of a parametric ultrasonic wave or a HSS signal in accordance with various embodiments holds particular advantages over conventional assistive hearing devices. That is, various embodiments, through the use of ultrasonics, may be configured to provide a perfect or at least near-perfect transient response, which can improve clarity, as opposed to conventional audio systems that can experience various types and/or varying amounts of distortion due to, e.g., the mass and/or resonance of drivers, enclosures, delay, etc.

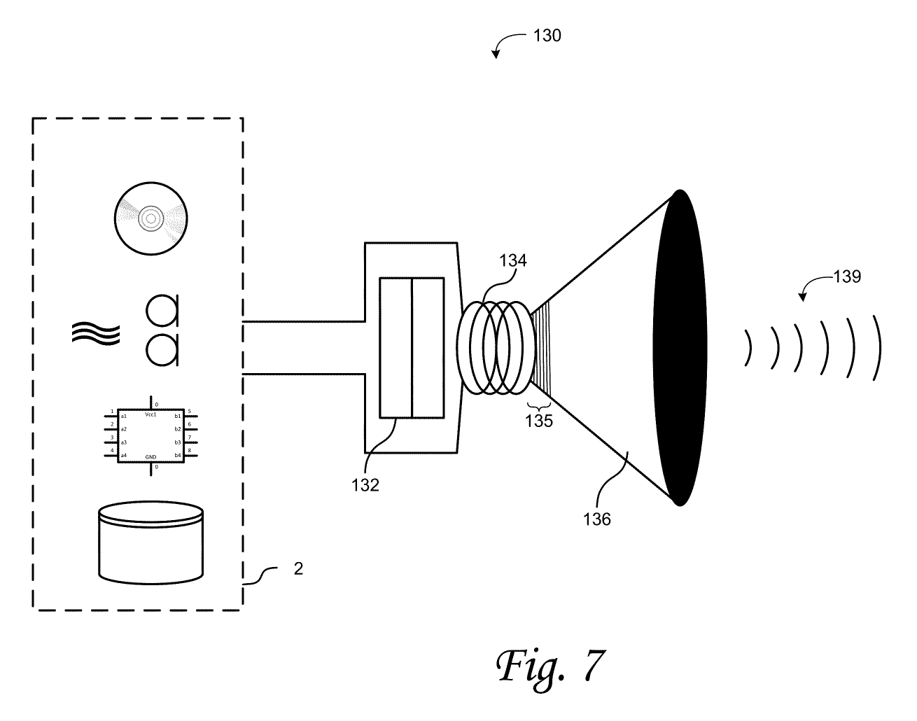

Still other embodiments are directed to the use of ultrasonic emitters, such as those herein described, for headphones, earbuds, assistive listening devices (e.g., hearing aids) and the like. FIG. 7 illustrates a schematic diagram of a conventional sound system 130. Sound system 130 may receive audio content from an audio source 2, such as audio source 2 of FIG. 1. Again, audio source 2 may be, e.g., a microphone, memory, a data storage device, streaming media source, MP3, CD, DVD, set-top-box, or other audio source, where the audio content can be decoded and converted from digital to analog form, depending on the source. The audio content received by sound system 130 may be received via speaker cables.

At the front of a loudspeaker, and facing outward is a diaphragm 136, which can be fabric, plastic, paper, or lightweight metal cone. The outer portion of diaphragm 136 may be attached to an outer portion of the loudspeaker's circular metal rim or frame (not shown). An inner portion of diaphragm 136 may be fixed to a coil 134, e.g., an iron coil (also referred to as a voice coil) that is positioned just in front of a permanent magnet 132 (also referred to as a field magnet) via a spider 135, which can be some piece of, e.g., accordion-shaped material that moves with coil 134 and diaphragm 136. The electrical signals (representative of the audio content from audio source 2) are fed via speaker cables into coil 134, thereby making coil 134 act like a temporary magnet or electromagnet. As the electricity flows back and forth in the speaker cables, coil 134 (acting as an electromagnet) either attracts or repels permanent magnet 132. This in turn moves coil 134 backward and forward resulting in pulling and pushing of diaphragm 136, thereby pumping sound 139 into the air.

Although not shown in FIG. 7, most loudspeakers rely on the initial audio signal to determine how loudly and quickly coil 134 moves, controlling the sound waves and creating contrast in them. Speaker drivers, which typically have three sizes, e.g., woofer (large), midrange (medium) and tweeter (small), can be employed to reproduce different frequency ranges and may also determine the sound waves. Low sounds, which have a lower frequency rate, or rate at which coil 134 moves, typically sound best coming from a large driver. Smaller drivers, e.g., tweeters, are able to vibrate at a much faster rate than woofers because they have less mass, and so higher frequency sounds transmit best through them.

Conventional headphones work in much the same way as loudspeakers, the difference being size. While a loudspeaker relies on moving air in a room, the speaker(s) in headphones only moves the volume of air inside the ear canal. Accordingly, headphones may be thought of as two loudspeakers mounted on a strap for clamping or retention about a user's head or simply in order to orient the headphones proximate to the ears. Earbuds also work in much the same way but again, in a smaller form factor still.

Headphones and earbuds, can usually be categorized into two types, e.g., closed-back headphones, which are sealed at the back so (theoretically) no sound escapes (or leaks in from outside the headphones/earbuds); while open-back headphones are open to the air at the back as well as the front. In the case of in-ear headphones/earbuds, the ear pieces must be placed far within the ear canal to form a seal with the ear canal via some form of malleable foam or other material. While this aids in combating leaking sound/passive noise cancellation and assists with bass response, many users find such in-ear headphones to be uncomfortable, as well as dangerous in certain circumstances as all or much of the ambient noise/sound is blocked. Accordingly, conventional headphones and earbuds have certain drawbacks.

As alluded to above, and in accordance with various embodiments, headphones and earbuds, as well as hearing aids and assistive listening devices, and the like can be configured with ultrasonic emitters in place of or in addition to conventional speakers, such as those described herein. The advantages described herein with respect to ultrasonic emitters, such as highly directional audio transmission, for example, can be achieved in the context of headphones as well. That is, sound may be optimally directed within a user's ear canal for better audio perception, as well as lessening or negating the escape/leaking of sound without being uncomfortable or dangerous.

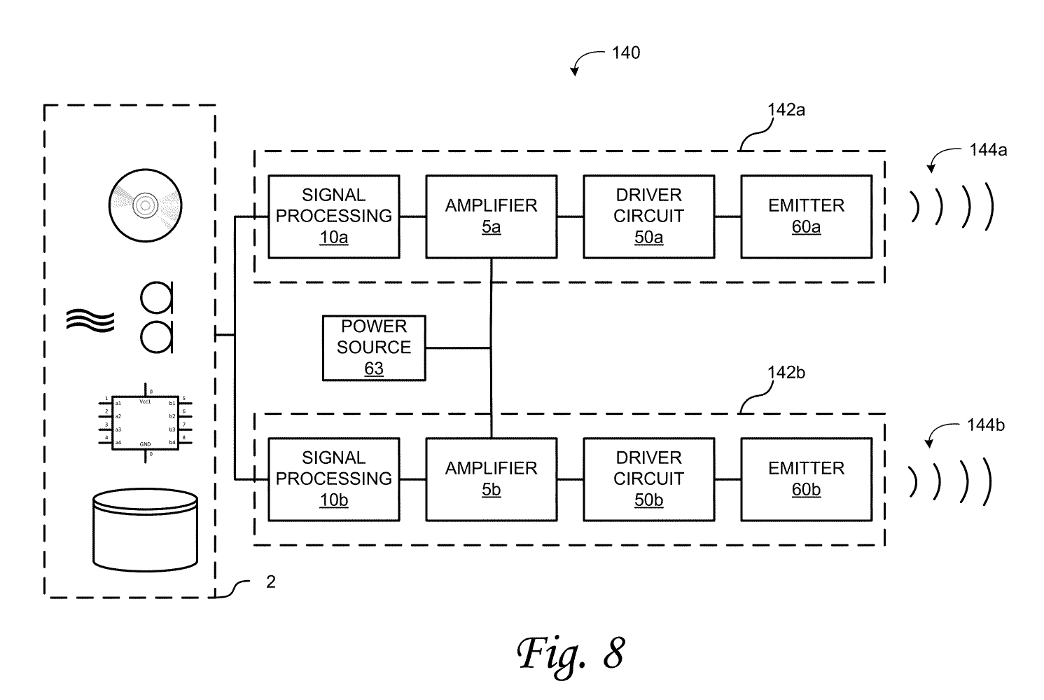

FIG. 8 is a block diagram illustrating an example ultrasonic headphone system 140 (which can be thought of as an “integrated sound system” as the various components/elements as will be described below can be co-located in headphone enclosures or housings), although one or more components/elements may be separately implemented/housed in accordance with other embodiment. For example, an amplifier may be co-located on an emitter portion of the ultrasonic headphones or separately therefrom. Similar to ultrasonic sound system 1 of FIG. 1, ultrasonic headphone system 140 can receive audio content from an audio source 2. Audio source 2 may be, e.g., a microphone, memory, a data storage device, streaming media source, MP3, CD, DVD, set-top-box, or other audio source, where the audio content can be decoded and converted from digital to analog form, depending on the source. The audio content may be received by ultrasonic headphone system 140 via the appropriate cables/wires. FIG. 8 illustrates ultrasonic headphone system 140 in a stereo configuration having, e.g., left and right channels/portions 142a, 142b. However, ultrasonic headphone system 140 may be configured as, e.g., a mono-aural headphone system as well.

Upon receipt of the audio signal, the audio content undergoes signal processing, as described previously, in signal processing systems 10a, 10b. That is, the audio signal input into ultrasonic headphone system 140 may be equalized to boost or suppress, as desired, one or more frequencies or frequency ranges. After equalization, the audio signal may be compressed to raise/lower certain portions of the audio signal. Filtering may also be performed to further refine the audio signal. Thereafter, the audio signal can be modulated onto an ultrasonic carrier, e.g., using a modulator that can include a local oscillator to generate the ultrasonic carrier signal and a multiplier to modulate the audio signal on the carrier signal.

The modulated ultrasonic signal may then be amplified using amplifiers 5a, 5b, e.g., for each channel. It should be noted that while standard headphones require, e.g., 5 mW of power, additional power may be needed to drive amplifiers 5a, 5b, for example, upwards of 100 mW, such as from power source 63. In one embodiment, ultrasonic headphone system 140 may be powered via power source 63, where power source 63 is a universal serial bus (USB) power source. It should be noted that in accordance with other embodiments, another power source/type of power source may be utilized to supply the requisite power needs of ultrasonic headphone system 140, such as, e.g., a battery power source, an external (e.g., remote from the headphone enclosures) power source, etc. Although two amplifiers 5a, 5b are illustrated and described in accordance with this embodiment, it should be noted that only a single amplifier may be used for both channels (where ultrasonic headphone system 140 is a stereophonic system) in driving ultrasonic headphone system 140, where the single amplifier is housed in either headphone enclosure or portion.

After amplification, the modulated ultrasonic signal is delivered to driver circuits 50a, 50b, which connects to emitters 60a, 60b. As described previously, emitters 60a, 60b can be operable at ultrasonic frequencies, thereby launching ultrasonic signals into the air (within a user's ear canal) creating ultrasonic waves 144a, 144b.

Emitters 60a, 60b, like the emitter of FIG. 3, may each comprise a conductive surface 45 and backing plate 49, where backing plate 49 can be implemented as a printed circuit board (or other like material) with a metalized layer deposited thereon. Accordingly, amplifiers 5a, 5b, driver circuits 50a, 50b, and signal processing systems 10a, 10b may be implemented on the respective backing plates of emitters 60a, 60b.

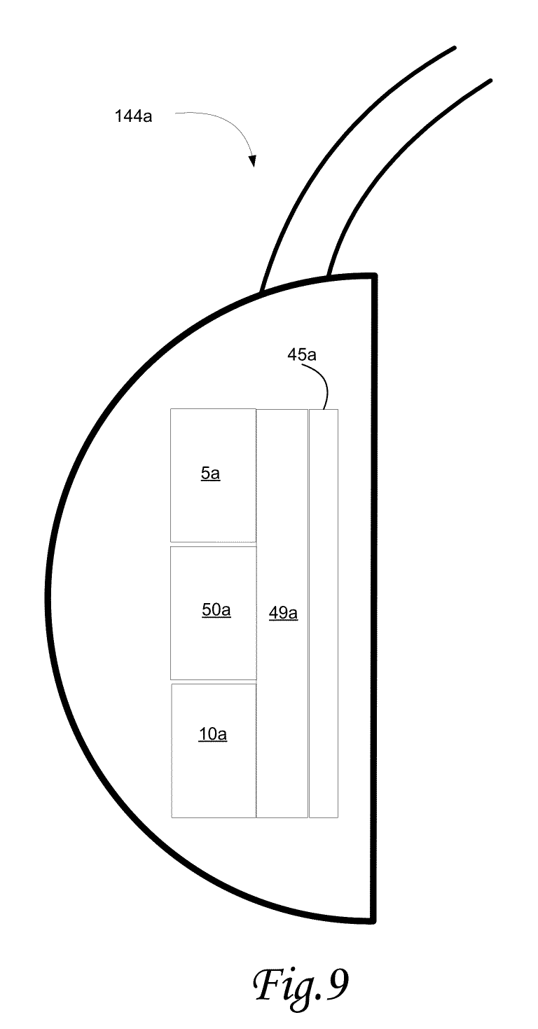

FIG. 9 illustrates a perspective view of the left channel of ultrasonic headphone system 144a, in accordance with one embodiment, where a first side of a backing plate 49a of emitter 60a may be processed, such as by etching, to provide the requisite circuitry to implement amplifier 5a, driver circuit 50a, and signal processing system 10a. A second side opposite the first side of backing plate 49a may have sputtered, laminated, or otherwise deposited thereon, other components making up emitter 60a, e.g., conductive surface 45a.

As this example illustrates, in various embodiments, backing plate 49a can be implemented as a printed circuit board (e.g., a multi-layer printed circuit board) that can function as both a backing plate for an emitter and a circuit board for components of the, or for all or part of, an ultrasonic headphone system. In such an example, the components of the ultrasonic headphone system may mounted on one side of the printed circuit board and signal paths can be formed on one or more layers of the printed circuit board. One or more vias can be used to provide the electrical connection for the signal path to the conductive surface of the backing plate of the emitter. For example, the inductors described above for creating resonance with the emitter and for impedance matching regarding the amplifier, may be, e.g., embedded inductors, implemented on the printed circuit board using printed/imaged conductor windings and a ferrite substrate or implanted ferrite core. In various embodiments, each emitter in a multi-channel audio system can have its own integrated sound system, whereas in other embodiments, a given emitter includes an integrated sound system and the signals distributed from that emitter to one or more other emitters in the system.

It should be noted that in embodiments where an amplifier is integrated into/with the ultrasonic headphone systems, embodiments may be implemented in which the aforementioned inductor(s) may be omitted.

Further still, ultrasonic headphone system can be configured to receive audio signals wirelessly from an audio source 2. That is, a wireless receiver (not shown), such as a radio frequency (RF) receiver operative in one or more industrial, scientific, and medical (ISM) bands (such as the 900 MHz band, the 2.4 GHz band, etc.), a Bluetooth®-based wireless receiver, etc., may receive audio signals. The wireless receiver can be configured to decode/demodulate the audio signals and forward them to the respective signal processing circuits 10, 10b of ultrasonic headphone system 140.

Although various embodiments described herein are described in the context of on-the-ear or over-the-ear sized headphones, smaller sizes can be implemented. For example, as noted above, the various components including the emitters can be miniaturized and sized to fit into earbud product configurations, or hearing aid or other assistive listening device configurations. For example, in the case of earbuds, one or more ultrasonic transducers can be fitted into the body of each bud to provide ultrasonic audio content to the listener. As a further example, the ultrasonic transducers can be implemented using piezoelectric transducers (e.g. PVDF) to deliver the audio-modulated ultrasonic signal. Likewise, one or more ultrasonic transducers can be fitted into an assistive listening device such as, for example, an over-the-ear or in-ear hearing aid.

It should be noted that although various embodiments are described herein as having the signal processing, amplification, and driving functions integrated with one or more emitters, other embodiments need not have one or more of signal processing systems 10a, 10b, amplifiers 5a, 5b, and driver circuits 50a, 50b integrated with emitters 60a, 60b, respectively. For example, amplifiers 5a, 5b may be housed within their own respective enclosure(s). This may reduce the size and/or weight of the emitter portions of ultrasonic headphone system 140 that is in physical contact with the user.

It should further be noted that ultrasonic headphone system 140 can be configured as open-back headphones. This is done to relieve/release pressure and/or reflections that might overload emitters 60a, 60b. However, piezoelectric film transducers/emitters may be utilized in accordance with other embodiments in place of electrostatic emitters, which can allow for a sealed ultrasonic headphone system configuration. Further still, a phased array of piezoelectric film transducers/emitters can be utilized in each of the left and right portions of ultrasonic headphone system 140 to achieve various spatial and/or “3D” audio effects. In accordance with still other embodiments, ‘hybrid’ transducers can be utilized, where a voice coil can be used to directly drive the emitter instead of the high voltage electrical field used in the previously described electrostatic emitter embodiments.

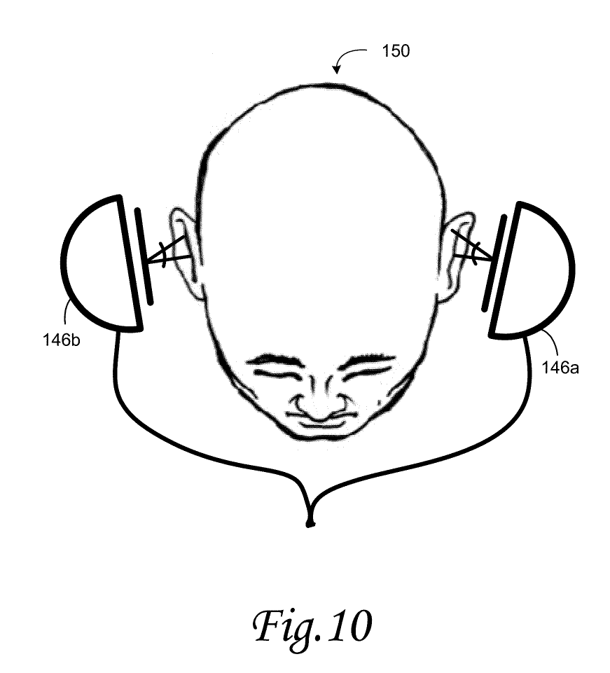

In order to optimize directionality of the ultrasonic waves emitted from emitters 60a, 60b, emitters 60a, 60b can be implemented on an adjustable base or enclosure. FIG. 10 illustrates left and right portions of ultrasonic headphone system 146a, 146b directed to left and right ears of user 150. For example, emitters 60a, 60b may be mounted onto a ball joint that can be rotated within a socket in each of housings/enclosures 146a, 146b of ultrasonic headphone system 140, and held in place via a friction fit. In accordance with another example, emitters 60a, 60b may be mounted on a rack and pinion arrangement or ratcheting-adjustment mechanism. It should be noted that nearly any type of adjustable mechanism may be used to allow for adjusting and setting emitters 60a, 60b in a desired position and orientation relative to the ears/ear canals of a user. Accordingly, emitters 60a, 60b may be configured to be adjustable in one or more directions simultaneously, e.g., horizontally, vertically, pitched, rolled, etc. and/or mounted in any desired position or orientation.

In accordance with some embodiments, emitters 60a, 60b may be mounted in a fixed position and orientation. For example, headphones can be configured with the emitters oriented in such a way that the emitted ultrasonic signal travels toward the ear canal of the listener. The position or angle of direction in which emitters 60a, 60b face relative to the ears of user 150 can vary, depending on the size of the earphone housings and depth of placement of the emitters therein. For example, in some embodiments the emitters are angled approximately 20 degrees towards the front of the head of user 150 in order to achieve an optimal direction of ultrasonic wave transmission into the ear canals. In other embodiments, other mounting angles can be used. As a further example, angles in the range of 5-30 degrees can be used.

In still further embodiments, configurations can be implemented in which multiple emitters are included and disposed in each of the earpieces of the ultrasonic headphones. For example, two or more emitters, whether piezo, electrostatic or otherwise, can be positioned within the earpieces and oriented such that the signals emitted therefrom can be directed at different points of the listener's ear (e.g., the pinna as previously described) or head. For example, multiple emitters can be included and oriented such that one emitter is aimed toward the listener's ear canal, a second emitter is aimed toward the upper portion of the pinna of the listener, and yet another emitter is aimed at the lower portion of the pinna or earlobe. Further still, various embodiments may utilize multiple emitters, where different emitters can be assigned to emit sound of differing frequency ranges. For example, a first emitter can be utilized for reproducing sounds having a lower frequency rate, e.g., bass, and/or for emitting sound omni-directionally. Second and/or third emitters may be used to reproduce higher frequency sounds.

Moreover, other embodiments may utilize a combination of speaker types within each ear cup/portion of the ultrasonic headphone system 140. For example, each ear cup may have housed or otherwise implemented therein, both a conventional speaker element (e.g., voice coil-driven cone/dynamic driver) and an ultrasonic transducer (e.g., electrostatic or piezo emitter). In accordance with such an embodiment, either transducer may be configured to operate with the same or differing frequency response(s). That is, the conventional transducer may be configured to operate as a full-range driver or a bass driver, for example, whereas the ultrasonic transducer may be configured to operate as a high frequency driver, for example. As another example, each transducer may be associated with a different channel.

Such configurations may be used to enhance the audio quality of the ultrasonic headphones. For example, while typical headphones may deliver fine audio quality, there is a certain amount of realism that may be lost. Particularly, when audio is delivered to a listener using external audio speakers (i.e., non-headphones), the sound that arrives at the listener's ears is a combination of sounds traveling directly from the speakers along with sound that reaches the listener after reflecting off the walls, the ceiling or other surfaces in the listening environment. Accordingly, external speakers can provide a more spatial sound as influenced by the listening environment. Much of this spatial quality may be lost through headphones, however, as the sound is generated directly proximate the ear and therefore does not exhibit the same multipath effects as external speakers. Accordingly, using highly directional ultrasonic emitters aimed at different directions within an earpiece of the headphones, can simulate this effect.

In some embodiments, the effect of aiming the emitters in different directions in the earpiece and allowing the ultrasonic signal to bounce off the pinna and reach the ear canal by a different path may be sufficient. That is, the pinna's functionality as an amplifier, acoustic filter, and directional guide can be leveraged by directing audio (from one or more emitters) relative to it.

In other embodiments, attenuating or amplifying the signals relative to one another, or adjusting their phase relative to one another may further enhance this effect. For example, it may be desirable to attenuate and phase delay the signals provided to the indirect emitters such that the multipath effect of a live room environment is more closely simulated. For example, delay can be used simulate a spatial echo, while attenuation can be used to mimic sound sources at different distances. Hence, one or more algorithms, for example, can be used to shape sound by altering signal strength/levels, frequency, timing, etc. to, e.g., mimic audio source locations. Such algorithms may also rely upon reverberation and head-related transfer functions, which refers to a response that characterizes how an ear received sound from a point in space can synthesize binaural sound, to “create” sounds sources, synchronize/de-synchronize sound, etc.

For example, 3D sound or audio effects can be achieved through the use of, e.g., phase delay and amplitude adjustments of one channel relative to the other, reverberation and the application of head-related transfer functions (HRTF) to simulate sound sources above, behind, and below the listener, for example. That is, HRTF can refer to a linear function based on a sound source's position. The HRTF can take into account, how humans, via the torso, pinna, and other cues, localize sounds. Accordingly, response filters can be developed for specific sound sources/positions, and subsequently applied to the relevant sound(s) to ‘place’ the sound in a virtual location.

Accordingly, sound processing circuitry can be included with the system to adjust the qualities (e.g., phase, attenuation, compression, equalization, and so on) of the signals provided to each of the various emitters to enhance the effect provided by including multiple emitters. Similarly, the multiple emitters within each earpiece can be configured with adjustable mounts so their orientation can be changed, or fixed mounts as previously alluded to and described in greater detail below.

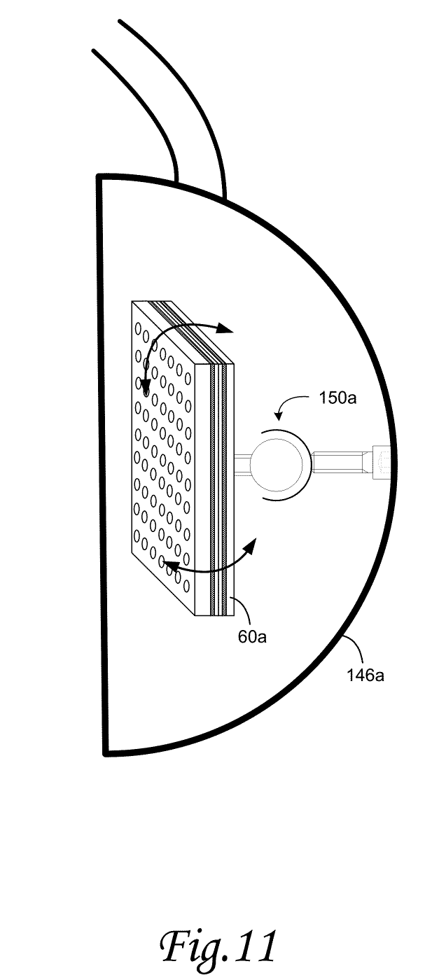

FIG. 11 is a cutaway diagram of ultrasonic headphone housing 146a in accordance with one embodiment. As described above, one mechanism that may be utilized to orient an emitter in a desired position, e.g., relative to a user's ear/ear canal, is a ball and socket joint. FIG. 11 illustrates that emitter 60a may be mounted to the “ball” portion of ball and socket joint 150a, which may be received in the “socket” portion of ball and socket joint 150a. Accordingly, a frontal plane of emitter 60a may be rotatably positioned and/or fixed in a desired position, e.g., at an angle 20 degrees towards the rear of the user's ear/ear canal. It should be noted that ball and socket joint 150a may be utilized, in accordance with some embodiments to orient and thereafter maintain emitter 60a in a desired position, or alternatively can be made accessible to the user to allow for adjustments to be made by the user.

In further embodiments, the adjustment mechanism to allow the orientation of the emitter to be changed can be controlled electronically using external signaling. Accordingly, the sound qualities delivered to the listener can be altered by adjusting the positioning and orientation of the emitters during the listening event. For example, the audio signal delivered by the audio source may be encoded with additional information they can be used to alter the position or orientation of the emitters. As a further example, in a gaming environment signals to control the position and orientation of the emitter can be generated to adjust the emitter based on occurrences in the game. Similar techniques can be used to adjust the audio experience for television or movie program content to provide a more spatial effect using information encoded on the signal line delivered to the headphones. Accordingly, in such embodiments, motorized mounts can be provided to adjust the position or orientation of the emitters based on these encoded signals.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus, the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. An ultrasonic headphone system, comprising:
two ultrasonic audio speakers, each comprising:
a backing plate; and
a flexible layer disposed adjacent the backing plate, the backing plate and the flexible layer achieving a resonant frequency, and each configured to be electrically coupled to a respective one of a pair of signal lines carrying the audio modulated ultrasonic carrier signal from an amplifier, wherein upon application of the audio modulated ultrasonic carrier signal, the flexible layer is configured to launch a pressure-wave representation of the audio modulated ultrasonic carrier signal into the air, a frequency of an ultrasonic carrier from which the audio modulated ultrasonic carrier signal is generated being at or near the resonant frequency; and
two headphone housings, each of the headphone housings holding one of the two ultrasonic audio speakers, wherein each of the two ultrasonic audio speakers are adjustable within and independently of the two headphone housings.

2. The ultrasonic headphone system of claim 1, wherein at least one of the two ultrasonic speakers further comprises an amplifier integrated directly onto the backing plate for amplifying an audio modulated ultrasonic carrier signal.

3. The ultrasonic headphone system of claim 1, wherein at least one of the two ultrasonic speakers further comprises a driver circuit integrated directly onto the backing plate for driving each of the two ultrasonic speakers using the audio modulated ultrasonic carrier signal from the amplifier.

4. The ultrasonic headphone system of claim 1, wherein at least one of the two ultrasonic speakers further comprises a signal processing circuit integrated directly onto the backing plate for at least one of equalizing, compressing, and filtering an audio signal used in modulation of the audio modulated ultrasonic carrier signal.

5. The ultrasonic headphone system of claim 2, wherein the backing plate of at least one of the two ultrasonic speakers comprises a printed circuit board.

6. The ultrasonic headphone system of claim 5, wherein a first side of the printed circuit board backing plate comprises an etched surface upon which circuitry for the amplifier is placed.

7. The ultrasonic headphone system of claim 6, wherein a conductive region of the flexible layer is disposed on a second side of the printed circuit board backing plate.

8. The ultrasonic headphone system of claim 1, wherein each of the two headphone housings comprises an orienting mechanism configured to maintain each of the two ultrasonic audio speakers in a predetermined position relative to a user's ears.

9. The ultrasonic headphone system of claim 8, wherein the orienting mechanism is user-adjustable.

10. The ultrasonic headphone system of claim 8, wherein the orienting mechanism maintains each of the two ultrasonic audio speakers in a position such that a frontal plane of each of the two ultrasonic audio speakers through which launching of the pressure-wave representation of the audio modulated ultrasonic carrier signal occurs is oriented 20 degrees towards the rear of each of the user's ears.

11. The ultrasonic headphone system of claim 1, wherein each of the two ultrasonic audio speakers comprises either an electrostatic emitter or a piezoelectric film emitter.

12. The ultrasonic headphone system of claim 2, further comprising a power source configured to drive at least the amplifier.

13. An ultrasonic headphone system, comprising:
an amplifier;
two headphone earpiece housings;
first and second emitters, each mounted in a respective one of the earpiece housings and each comprising:
a backing plate; and
a flexible layer disposed adjacent the backing plate, the backing plate and the flexible layer achieving a resonant frequency, and each configured to be electrically coupled to a respective one of a pair of signal lines carrying the audio modulated ultrasonic carrier signal from the amplifier, wherein upon application of the audio modulated ultrasonic carrier signal, the flexible layer is configured to launch a pressure-wave representation of the audio modulated ultrasonic carrier signal into the air, a frequency of an ultrasonic carrier from which the audio modulated ultrasonic carrier signal is generated being at or near the resonant frequency, and wherein each of the first and second emitters are adjustable within and independently of the two headphone earpiece housings;
a signal processing module for equalizing, compressing, and filtering first and second audio signals for modulating the audio signals onto respective ultrasonic carriers; and
first and second amplifiers for amplifying the audio modulated ultrasonic carrier signals.

14. The ultrasonic headphone system of claim 13, wherein each of the first and second emitters comprise:
the backing plate comprising a first major surface and a conductive region, the backing plate further comprising a plurality of textural elements disposed on the first major surface; and
the flexible layer disposed adjacent the first major surface of the backing plate, the flexible layer comprising a conductive region and an insulative region, wherein the flexible layer is disposed adjacent the backing plate such that the insulative region is positioned between the backing plate and the conductive region of the flexible layer, and such that there is a volume of air between the flexible layer and surfaces of the textural elements;
wherein the backing plate and the flexible layer are each configured to be electrically coupled to the respective one of a pair of signal lines carrying the first and second audio modulated ultrasonic carrier signals, and further wherein, upon application of one of the first and second audio modulated ultrasonic carrier signals, the flexible layer is configured to launch the pressure-wave representation of a respective one of the first and second audio modulated ultrasonic carrier signals into respective ear canals of a listener.

15. The ultrasonic headphone system of claim 14, wherein the backing plate of at least one of the emitters comprises a printed circuit board backing plate.

16. The ultrasonic headphone system of claim 15, wherein a first side of the printed circuit board backing plate comprises an etched surface upon which circuitry for a respective one of the first and second signal processing circuits is placed.

17. The ultrasonic headphone system of claim 16, wherein a conductive region of the flexible layer is disposed on a second side of the printed circuit board backing plate.

18. The ultrasonic headphone system of claim 16, wherein the signal processing module and amplifiers are encapsulated in at least one of first and second headphone housings, each of the first and second headphone housings comprising an orienting mechanism configured to maintain a respective one of the first and second emitters in a predetermined position relative to the respective ear canals of the listener.

19. The ultrasonic headphone system of claim 18, wherein the orienting mechanism is user-adjustable.

20. The ultrasonic headphone system of claim 18, wherein the orienting mechanism maintains a respective one of the first and second emitters in a position such that a frontal plane of a respective one of the first and second emitters through which launching of the pressure-wave representation of the first and second audio modulated ultrasonic carrier signal occurs is oriented 20 degrees towards the rear of the respective ear canals of the listener.

21. The ultrasonic headphone system of claim 14, wherein each of the first and second emitters comprises either an electrostatic emitter or a piezoelectric film emitter.

22. Ultrasonic headphones, comprising:
two headphone earpiece housings;
first and second ultrasonic audio speakers, each mounted in and adjustable within and independently of a respective one of the earpiece housings and each comprising:
a backing plate; and
a flexible layer disposed adjacent the backing plate, the backing plate and the flexible layer achieving a resonant frequency, and each configured to be electrically coupled to a respective one of a pair of signal lines carrying an audio modulated ultrasonic carrier signal from an amplifier, wherein upon application of the audio modulated ultrasonic carrier signal, the flexible layer is configured to launch a pressure-wave representation of the audio modulated ultrasonic carrier signal into the air, a frequency of an ultrasonic carrier from which the audio modulated ultrasonic carrier signal is generated being at or near the resonant frequency.

23. The ultrasonic headphones of claim 22, further comprising a first positionable mounting brackets on which the first ultrasonic audio speaker is mounted and a second positionable mounting brackets on which the second ultrasonic audio speaker is mounted, the first and second positionable mounted brackets being positionable to orient the first and second ultrasonic audio speakers to direct audio modulated ultrasonic signals toward the ear canals of the listener.

24. The ultrasonic headphones of claim 23, wherein the positionable mounting brackets are user-adjustable.

25. The ultrasonic headphones of claim 23, wherein the positionable mounting brackets maintain each of the two ultrasonic audio speakers in a position such that a frontal plane of each of the two ultrasonic audio speakers through which launching of the pressure-wave representation of the audio modulated ultrasonic carrier signal occurs is oriented 20 degrees towards the rear of each of the user's ears.

26. Ultrasonic headphones, comprising:
two headphone earpiece housings;
a first set of audio speakers mounted in each of the earpiece housings, each comprising:
a backing plate; and
a flexible layer disposed adjacent the backing plate, the backing plate and the flexible layer achieving a resonant frequency, and each configured to be electrically coupled to a respective one of a pair of signal lines carrying an audio modulated ultrasonic carrier signal from an amplifier, wherein upon application of the audio modulated ultrasonic carrier signal, the flexible layer is configured to launch a pressure-wave representation of the audio modulated ultrasonic carrier signal into the air, a frequency of an ultrasonic carrier from which the audio modulated ultrasonic carrier signal is generated being at or near the resonant frequency; and
a second set of audio speakers mounted in each of the earpiece housings, wherein each of the first and second sets of audio speakers are adjustable within and independently of the two headphone earpiece housings.

27. The ultrasonic headphones of claim 26, wherein each of the second set of audio speakers comprises a dynamic loudspeaker.

28. Ultrasonic headphones, comprising:
two headphone earpiece housings;
a first set of audio speakers mounted in each of the earpiece housings, each comprising:
a backing plate; and
a flexible layer disposed adjacent the backing plate, the backing plate and the flexible layer achieving a resonant frequency, and each configured to be electrically coupled to a respective one of a pair of signal lines carrying an audio modulated ultrasonic carrier signal from an amplifier and driven directly by a voice coil such that the flexible layer is configured to launch a pressure-wave representation of the audio modulated ultrasonic carrier signal into the air, a frequency of an ultrasonic carrier from which the audio modulated ultrasonic carrier signal is generated being at or near the resonant frequency; and
a second set of audio speakers mounted in each of the earpiece housings, wherein each of the first and second sets of audio speakers are adjustable within and independently of the two headphone earpiece housings.

29. The ultrasonic headphones of claim 28, wherein each of the second set of audio speakers comprises a dynamic loudspeaker.
